(19) United States
(12) Patent Application Publication
(10) Pub. No.: US 2026/0004132 A1
(43) Pub. Date: Jan. 1, 2026

(54) DEVICE AND METHOD FOR CONTROLLING A ROBOT BASED ON A PRUNED MODEL

(71) Applicants: Hyundai Motor Company, Seoul (KR); Kia Corporation, Seoul (KR); Seoul National University R&DB Foundation, Seoul (KR)

(72) Inventors: Minkyu Lee, Hwaseong-Si (KR); Dongheon Shin, Hwaseong-Si (KR); Kyoung Mu Lee, Seoul (KR); Seok II Hong, Seoul (KR)

(21) Appl. No.: 18/966,503

(22) Filed: Dec. 3, 2024

(30) Foreign Application Priority Data
Jun. 27, 2024 (KR) 10-2024-0084184

(51) Int. Cl. G06N 3/082; B25J 9/16

(52) U.S. Cl. CPC G06N 3/082; B25J 9/161; B25J 9/163

(57) ABSTRACT

An apparatus for controlling a robot comprises a processor and memory storing instructions, which, when executed by the processor, cause the apparatus to determine weighting values for multiple layers in a pre-trained deep learning model based on similarities among channels within each layer. Each layer is assigned a respective weighting value. The apparatus further determines a first pruning rate for all layers based on the inference time of the model, reflecting the time required for input processing and output prediction. A second pruning rate for each layer is determined by multiplying the first pruning rate by the corresponding weighting value, followed by random channel removal at this rate to prune the layers. The apparatus then outputs a signal based on the pruned layers and uses this signal to control the robot.

### CROSS-REFERENCE TO RELATED APPLICATION

This application claims the benefit of priority to Korean Patent Application No. 10-2024-0084184 filed in the Korean Intellectual Property Office on Jun. 27, 2024, the entire contents of which are incorporated herein by reference.

### TECHNICAL FIELD

The disclosure relates to a device and method for controlling a robot based on a pruned deep learning model.

### BACKGROUND

The matters described in this Background section are only for the enhancement of understanding of the background of the disclosure, and should not be taken as acknowledgment that they correspond to prior art already known to those skilled in the art.

High-performance deep learning models may use a large amount of learning data and a large amount of computation. Therefore, algorithm pruning technology may be applied to operate a high-performance deep learning model in real time in a robot system with limited memory.

Pruning deep learning models may not only reduce model parameters but also enable acceleration. However, there is no a standard for how much channels should be pruned by layer. Pruning techniques may perform channel pruning at the same rate in all layers of a deep learning model or require additional resources and time (e.g., additional data learning or memory allocation) to determine a pruning rate by layer, which may incur heavy costs in applying pruning techniques.

### SUMMARY

The effects that may be obtained from the disclosure are not limited to the effects mentioned above, and other effects that are not mentioned may be clearly understood by those skilled in the art to which the disclosure pertains from the description below.

According to the present disclosure, an apparatus for controlling a robot, the apparatus may comprise, a processor, a memory storing instructions that, when executed by the processor, are configured to cause the apparatus to, determine, based on a similarity between a plurality of channels included in each of a plurality of layers, a plurality of weighting values for the plurality of layers, wherein the plurality of layers are included in a pre-trained deep learning model, and wherein each of the plurality of layers corresponds to a respective one of the plurality of weighting values, determine, based on an inference time of the pre-trained deep learning model, a first pruning rate for all of the plurality of layers, wherein the inference time is associated with an amount of time taken for the pre-trained deep learning model to receive input data and predict an output value, determine a second pruning rate for each of the plurality of layers by multiplying the first pruning rate by the respective one of the plurality of weighting values, randomly remove at least one of the plurality of channels at the second pruning rate for each of the plurality of layers to prune each of the plurality of layers, output, based on the pruned plurality of layers, a signal, and control, based on the signal, the robot.

The apparatus, wherein the instructions, when executed by the processor, are configured to cause the apparatus to determine, based on a cosine similarity, the similarity between the plurality of channels.

The apparatus, wherein the instructions, when executed by the processor, are configured to cause the apparatus to determine, based on a Euclidean distance, the similarity between the plurality of channels.

The apparatus, wherein the instructions, when executed by the processor, are configured to cause the apparatus to determine, based on a Jensen-Shannon divergence (JSD), the similarity between the plurality of channels.

The apparatus, wherein the instructions, when executed by the processor, are configured to cause the apparatus to determine, based on a plurality of similarities between a plurality of channels of a first layer of the plurality of layers, a mean value of the plurality of similarities, wherein the mean value represents the weighting value of the first layer.

The apparatus, wherein the instructions, when executed by the processor, are configured to cause the apparatus to determine, based on a plurality of similarities between a plurality of channels of a first layer of the plurality of layers, a sum of similarities that are higher than a reference value among the plurality of similarities, wherein the sum represents the weighting value of the first layer.

The apparatus, wherein the instructions, when executed by the processor, are configured to cause the apparatus to determine, based on a plurality of similarities between a plurality of channels of a first layer of the plurality of layers, a mean value of top N similarities having a largest similarity value among the plurality of similarities, wherein the mean value of top N similarities represents the weighting value of the first layer.

The apparatus, wherein the instructions, when executed by the processor, are configured to cause the apparatus to normalize each of the plurality of weighting values within a preset range. The apparatus, wherein the preset range is between 0.5 and 1.5.

The apparatus, wherein the instructions, when executed by the processor, are configured to cause the apparatus to determine the first pruning rate for all of the plurality of layers, such that the inference time of the pre-trained deep learning model matches a reference value.

According to the present disclosure, a method performed by an apparatus for controlling a robot, the method may comprise, determining, based on a similarity between a plurality of channels included in each of a plurality of layers, a plurality of weighting values for the plurality of layers, wherein each of the plurality of layers corresponds to a respective one of the plurality of weighting values, determining, based on the plurality of weighting values and an inference time of a pre-trained deep learning model, a first pruning rate for all of the plurality of layers, determining a second pruning rate for each of the plurality of layers by multiplying the first pruning rate by the respective one of the plurality of weighting values, randomly removing at least one of the plurality of channels at the second pruning rate for each of the plurality of layers to prune each of the plurality of layers, outputting, based on the pruned plurality of layers, a signal, and controlling, based on the signal, the robot.

The method, wherein the similarity between the plurality of channels is determined based on a cosine similarity. The method, wherein the similarity between the plurality of channels is determined based on an Euclidean distance. The method, wherein the similarity between the plurality of channels is determined based on a Jensen-Shannon divergence (JSD).

The method, wherein the determining the plurality of weighting values may comprise, determining, based on a plurality of similarities between a plurality of channels of a first layer of the plurality of layers, a mean value of the plurality of similarities, wherein the mean value represents the weighting value of the first layer.

The method, wherein the determining the plurality of weighting values may comprise, determining, based on a plurality of similarities between a plurality of channels of a first layer of the plurality of layers, a sum of similarities that are higher than a reference value among the plurality of similarities, wherein the sum represents the weighting value of the first layer.

The method, wherein the determining the plurality of weighting values may comprise, determining, based on a plurality of similarities between a plurality of channels of a first layer of the plurality of layers, a mean value of top N similarities having a largest similarity value among the plurality of similarities, wherein the mean value of top N similarities represents the weighting value of the first layer.

The method, wherein the determining the plurality of weighting values may comprise, normalizing each of the plurality of weighting values within a preset range. The method, wherein the preset range is between 0.5 and 1.5.

The method, wherein the determining the second pruning rate may comprise, determining the first pruning rate for all of the plurality of layers, such that the inference time of the pre-trained deep learning model matches a reference value.

### BRIEF DESCRIPTION OF THE DRAWINGS

FIG. 1 is an example of a deep learning model according to an example of the disclosure.

FIG. 2 is an example of a deep learning model pruned by a deep learning model pruning device according to an example of the disclosure.

FIG. 3 is an exemplary block diagram of a deep learning model pruning device according to an example of the disclosure.

FIG. 4 shows an example of vectors of different channels.

FIG. 5 shows an example of output distributions of different channels.

FIG. 6 shows an example of a method for pruning a deep learning model according to an example of the disclosure.

### DETAILED DESCRIPTION

In describing the example, when a detailed description of the relevant known function or configuration is determined to unnecessarily obscure the important point of the disclosure, the detailed description will be omitted. The accompanying drawings of the disclosure aim to facilitate understanding of the disclosure and should not be construed as limited to the accompanying drawings. Also, the disclosure is not limited to a specific disclosed form but includes all modifications, equivalents, and substitutions without departing from the scope and spirit of the disclosure.

It will be understood that, although the terms first, second, etc. may be used herein to describe various elements, these elements should not be limited by these terms. These terms are only used to distinguish one element from another.

When it is mentioned that a component is “connected” or “coupled” to another component, it should be understood that it may be directly connected or coupled to the other component, but that there may be other components in between. Meanwhile, when it is mentioned that a component is “directly connected” or “directly coupled” to another component, it should be understood that there are no other components in between.

Throughout the specification, the terms, such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, the disclosure will be described in detail with reference to the accompanying drawings.

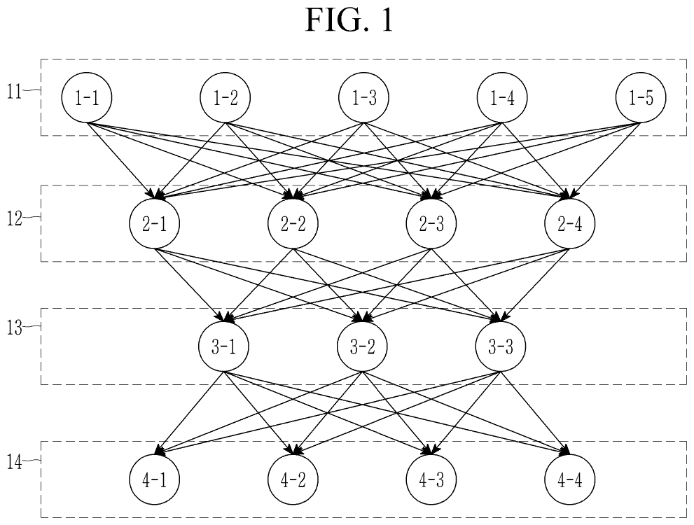

FIG. 1 is an example of a deep learning model according to an example of the disclosure.

Referring to FIG. 1, a deep learning model according to an example of the disclosure may include a plurality of layers 11, 12, 13, and 14, and each layer may include a plurality of channels. For example, as shown in FIG. 1, a deep learning model 10 may include four layers 11, 12, 13, and 14. Here, the four layers 11, 12, 13, and 14 may include an input layer 11 to which input data is applied, an output layer 14 that outputs a result value derived through prediction based on the input data, and a first hidden layer 12 and a second hidden layer 13 between the input layer 11 and the output layer 14. In addition, the input layer 11 may include five channels 1-1, 1-2, 1-3, 1-4, and 1-5, the first hidden layer 12 may include four channels 2-1, 2-2, 2-3, and 2-4, the second hidden layer 13 may include three channels 3-1, 3-2, and 3-3, and the output layer 14 may include four channels 4-1, 4-2, 4-3, and 4-4. However, a structure of the deep learning model 10 shown in FIG. 1 is only an example, and the structure of the deep learning model 10 of the disclosure is not necessarily limited thereto.

In addition, although the deep learning model 10 is shown as a fully-connected neural network in FIG. 1, the deep learning model 10 according to an example of the disclosure is not limited thereto and may include at least one of the fully-connected neural network, a convolutional neural network (CNN), and a recurrent neural network (RNN).

The deep learning model according to an example of the disclosure may be pre-trained. That is, the deep learning model 10 may have been completely trained to analyze input data and predict a specific result. For example, the deep learning model 10 may be a model that analyzes an input image and predicts whether an abnormal event occurs. That is, it may be an abnormal event detection model.

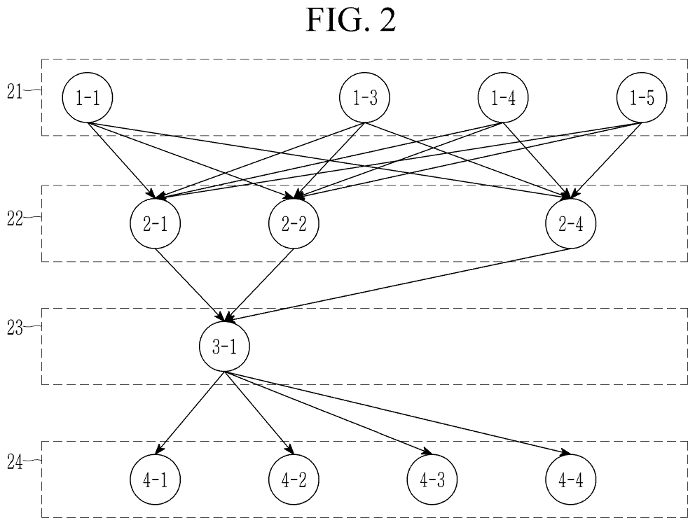

FIG. 2 is an example of a deep learning model 20 pruned by a deep learning model pruning device 100 according to an example of the disclosure. Pruning each of a plurality of layers in a deep learning model refers to a process of selectively removing certain elements (channels, neurons, or connections) within each layer of the deep learning model to reduce its size and complexity. Pruning may be used to make the deep learning model more efficient by decreasing a number of parameters the deep learning model stores and the amount of computation required during inference. Pruning each layer may involve analyzing the importance of channels (or filters) within each layer and removing those deemed less importance based on calculated values (e.g., importance scores). This process may be applied separately to each layer, allowing the pruning ratio (the proportion of channels removed) to vary between layers. The goal may be to maintain the deep learning model's performance while optimizing or enhancing the deep learning model to run faster and use less memory, which is particularly beneficial for applications on resource-limited devices.

Referring to FIG. 2, the deep learning model pruning device 100 according to an example of the disclosure may perform channel pruning for each of the plurality of layers 11, 12, 13, and 14 included in the pre-trained deep learning model 10. That is, the deep learning model pruning device 100 may remove some of a plurality of channels included in each of the plurality of layers 11, 12, 13, and 14. Here, the ratio of the channels removed from each layer may be different. For example, as shown in FIG. 2, the input layer 21 may have channels removed at a ratio of 20%, the first hidden layer 22 at a ratio of 25%, the second hidden layer 23 at a ratio of 66%, and the output layer 24 at a ratio of 0%.

Referring to FIGS. 1 and 2, the deep learning model pruning device 100 according to an example of the disclosure may prune the channel by removing some of the plurality of channels included in each of the plurality of layers 11, 12, 13, and 14 included in the pre-trained deep learning model 10 at different ratios.

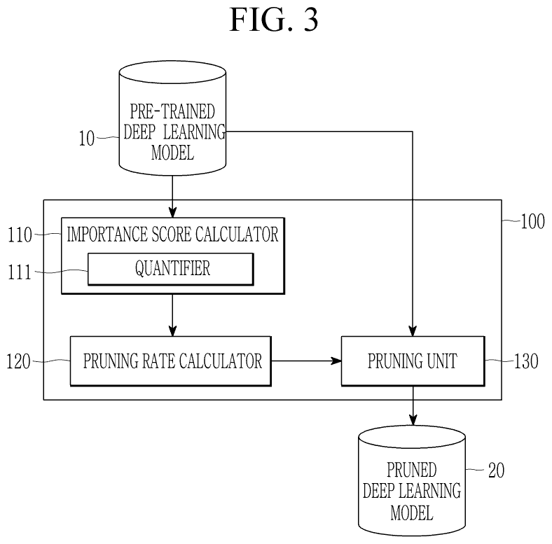

FIG. 3 is an exemplary block diagram of the deep learning model pruning device 100 according to an example of the disclosure.

Referring to FIG. 3, the deep learning model pruning device 100 according to an example of the disclosure may determine an importance score and a second pruning rate for each of the plurality of layers using the pre-trained deep learning model 10. In addition, each of the plurality of layers included in the pre-trained deep learning model 10 may be pruned at the second pruning rate to generate a pruned deep learning model 20. A pruning rate is the percentage or proportion of elements (such as channels, neurons, or connections) that are removed from a layer or a deep learning model during the pruning process. It may represent the extent to which the deep learning model is reduced or thinned out to make the deep learning model more efficient.

Referring to FIG. 3, the deep learning model pruning device 100 according to an example of the disclosure may include an importance score calculator 110, a pruning rate calculator 120, and a pruning unit 130.

The importance score calculator 110 may determine an importance score for each of a plurality of layers based on a similarity between a plurality of channels included in each of the plurality of layers included in the pre-trained deep learning model 10. In other words, the importance score calculator 110 may determine a similarity between the plurality of channels included in a layer. The importance score may refer to a numerical value assigned to each layer of a deep learning model that indicates the relative significance of that layer's channels (or neurons) in contributing to the model's overall performance. This score may be used to guide layer-specific pruning, where layers deemed less important are pruned more aggressively, while more important layers are pruned less or not at all. The importance score for each layer is determined based on the similarity between channels within that layer. This similarity is measured to determine how redundant or unique the channels are. The more redundant channels (e.g., similar channels) are within a layer, the less important the layer might be for maintaining model accuracy after pruning.

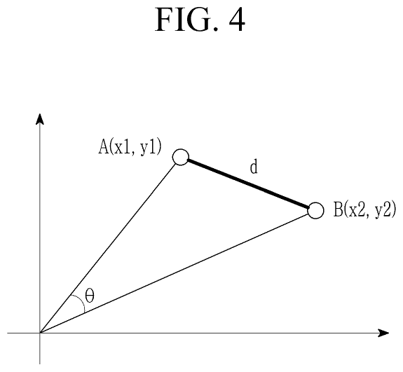

FIG. 4 shows an example of vectors A and B of different channels, respectively. Referring to FIG. 4, a similarity between a plurality of channels included in a layer may be calculated by a method of determining a similarity between the different vectors A and B. An output distribution of each of the plurality of channels included in the layer may be expressed as a normal distribution having a mean (x) and a standard deviation (y). Therefore, the similarity between the plurality of channels may be calculated using a method for determining a similarity between different normal distributions. Since the normal distribution may be expressed as the mean (x) and the standard deviation (y) vectors A and B, the similarity between the different normal distributions may be calculated by determining the similarity between the different mean (x) and standard deviation (y) vectors A and B. Therefore, the similarity between the plurality of channels of the disclosure may be calculated using a method for determining the similarity between the different vectors A and B.

According to an example, the importance score calculator 110 may determine the similarity between the plurality of channels using a cosine similarity or a Euclidean distance. Here, the cosine similarity is a value corresponding to θ in FIG. 4, which represents a directional similarity between the different vectors A and B. In addition, the Euclidean distance is a value corresponding to d in FIG. 4, which represents a physical distance between the different vectors A and B.

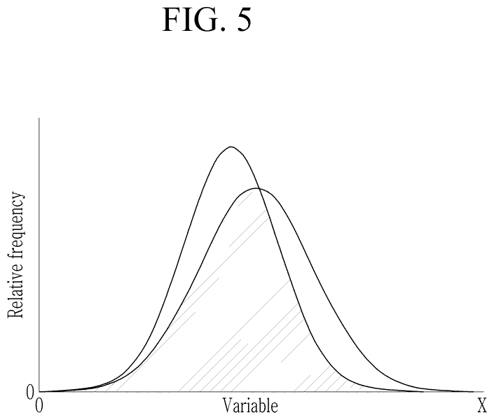

FIG. 5 shows an example of output distributions of different channels, respectively.

Referring to FIG. 5, a similarity between the plurality of channels included in a layer may be calculated by determining an overlapping region between normal distributions corresponding to output distributions of each channel. Here, the overlapping region between the normal distributions may be calculated through a method of determining a probability distribution similarity. Therefore, the similarity between the plurality of channels of the disclosure may be calculated using a method of determining the probability distribution similarity.

According to an example, the importance score calculator 110 may determine a similarity between the plurality of channels using a Jenson-Shannon divergence (JSD).

Here, JSD is one of the methods of determining a probability distribution similarity and is a method that applies a Kullback-Leibler divergence (KLD).

Meanwhile, since the output distribution for each of the plurality of channels may be represented by a normal distribution, KLD and JSD for determining the probability distribution similarity between the plurality of channels may be represented as [Equation 1] and [Equation 2] below, respectively.

That is, the importance score calculator 110 according to the disclosure may determine the similarity between the plurality of channels using [Equation 1] and [Equation 2] below, thereby simplifying an arithmetic operation for determining the similarity between the plurality of channels. Accordingly, the importance score calculator 110 according to the disclosure may rapidly determine the similarity value between the plurality of channels.

Meanwhile, a smaller JSD value calculated through [Equation 2] may indicate a higher similarity between the channels, and when different channels have the same output distribution, the JSD value becomes 0.

$${D}_{KL} ( p ‖ q ) = log \frac{{σ}_{2}}{{σ}_{1}} + \frac{{σ}_{1}^{2} + {( {μ}_{1} - {μ}_{2} )}^{2}}{2 {σ}_{2}^{2}} - \frac{1}{2} \qquad ( Equation 1 )$$

(Here, p and q denote output distribution by channel, σ denotes standard deviation, and μ denotes mean, respectively.)

$$JSD ( p ‖ q ) = \frac{1}{2} KL ( p ‖ M ) + \frac{1}{2} KL ( q ‖ M ) \\ where , M = \frac{1}{2} ( p + q ) \qquad ( Equation 2 )$$

(Here, p and q denote output distribution by channel.)

In addition, the importance score calculator 110 may determine importance scores for each of a plurality of layers based on the calculated similarity.

The similarity calculated by the importance score calculator 110 may be one or plural depending on the number of channels included in a layer. For example, if the number of channels included in a layer is 2, the similarity value between the channels calculated by the importance score calculator 110 is 1, whereas if the number of channels included in a layer is 3 or more, the similarity value between the channels calculated by the importance score calculator 110 is 3 or more, i.e., plural.

If the similarity calculated by the importance score calculator 110 is 1, the calculated one similarity value may be calculated as the importance score. Meanwhile, if the similarity calculated by the importance score calculator 110 is plural, a specific value calculated using the plurality of similarities may be calculated as the importance score.

According to an example, the importance score calculator 110 may determine a mean of the plurality of similarities as the importance score.

If the mean of the plurality of similarities is calculated as the importance score, there is an advantage in that the importance score may be calculated by a simple and intuitive method. However, if a channel pair whose similarity value differs significantly from the mean is included in the layer, there may be a disadvantage in that the corresponding similarity value may be diluted and a significant similarity value may not be reflected in the importance score.

According to an example, the importance score calculator 110 may determine the sum of similarities that are greater than or equal to a reference value among the plurality of similarities as the importance score.

That is, the importance score calculator 110 may filter only similarities that are greater than or equal to the reference value, determine the sum of the filtered similarities, and designate the sum as the importance score. Filtering of similarities that are greater than or equal to the reference value among the plurality of similarities has an advantage in that only meaningful similarities may be reflected. However, there is a disadvantage in that there may be a significant difference between the number of similarities used for determining the importance score for each layer.

According to an example, the importance score calculator 110 may determine the mean of the top N similarities having large similarity values among the plurality of similarities as the importance score.

That is, the plurality of similarities may be listed in order, starting from the greatest similarity value, and the mean of the top N similarities among them may be calculated as the importance score. When determining the mean of the top N similarities among the plurality of similarities as the importance score, the problem of significant similarity values being diluted may be solved and there may be an advantage of being able to reflect the same number of similarity values for each layer.

According to an example, the importance score calculator 110 may further include a quantifier 111. The quantifier 111 may quantify the importance score for each of the plurality of layers within a preset range. For example, the quantifier 111 may quantify or normalize the importance scores calculated from the plurality of layers so that they are all within a range of 0.5 to 1.5. This normalization may allow the pruning process to adapt to different deep learning models by standardizing the importance score, thereby achieving a balanced reduction in model size and maintaining model performance across different layers.

The pruning rate calculator 120 may determine a first pruning rate for all of the plurality of layers based on an inference time of the pre-trained deep learning model 10 and may determine a second pruning rate for each of the plurality of layers by multiplying the first pruning rate by the importance score. Here, the importance score may be received from the importance score calculator 110.

Here, the pruning rate refers to the degree to which the deep learning model is pruned in the pruning of the deep learning model. In other words, as the value of the pruning rate is greater, the degree to which the deep learning model is pruned increases. According to an example, the pruning rate may be expressed as a percentage (%) or a decimal point.

In addition, the first pruning rate refers to a pruning rate that is applied equally to all of the plurality of layers included in the deep learning model. For example, the first pruning rate of 20% means that all of the plurality of channels included in each of the plurality of layers are removed at the same rate of 20%.

According to an example, the pruning rate calculator 120 may determine the first pruning rate for all of the plurality of layers that render the inference time of the pre-trained deep learning model 10 a reference value.

Here, the inference time refers to a time taken for the pre-trained deep learning model 10 to receive input data (e.g., a photo or image file, a text document or snippet, a video file or real-time video feed, etc.) and predict an output value (e.g., for recognizing an object in an image, classifying text, or detecting anomalies in a video, etc.), and may be used as a performance evaluation index of the deep learning model.

In addition, the reference value may be a value obtained by dividing the inference time of the pre-trained deep learning model 10 by half. For example, if the inference time of the pre-trained deep learning model 10 is 100 ms, the pruning rate calculator 120 may determine the first pruning rate that may reduce the inference time to 50 ms. That is, the pruning rate calculator 120 may remove all of the plurality of channels included in each of the plurality of layers included in the deep learning model at the same rate and measure the inference time of the deep learning model after removing the plurality of channels at the same rate. In addition, if the measured inference time corresponds to 50 ms, the rate at which the plurality of channels are removed may be calculated as the first pruning rate.

The second pruning rate refers to a pruning rate applied to each of the plurality of layers included in the deep learning model. In other words, the second pruning rate may refer to a rate at which channels are removed from each layer. The second pruning rate may be calculated by multiplying the importance score calculated for each of the plurality of layers by the first pruning rate. Accordingly, the second pruning rate may be calculated for each of the plurality of layers. For example, if the first pruning rate is 0.6 and the importance scores of three different layers are [1.5, 1, 0.5], the second pruning rate becomes [0.9, 0.6, 0.3].

The pruning unit 130 may remove some of the plurality of channels for each of the plurality of layers at the second pruning rate to prune each of the plurality of layers. Here, the channels removed by the pruning unit 130 are randomly specified.

That is, the pruning unit 130 may receive the second pruning rate from the pruning rate calculator 120 and randomly remove some of the plurality of channels included in each of the plurality of layers by applying the second pruning rate corresponding to each of the plurality of layers included in the pre-trained deep learning model 10 input to the pruning unit 130. Alternatively or additionally, alternative pruning schemes may be used to selectively remove channels. For example, activation-based pruning may remove channels with the lowest average activations, assuming they contribute less to the deep learning model's decisions. Gradient-based pruning may focus on channels with the smallest gradients, which have minimal impact on reducing errors, and entropy-based pruning may remove channels with low entropy, suggesting lower information content. Structured pruning may eliminate entire filters or blocks with low importance scores, which may be beneficial for hardware efficiency. These alternative approaches may offer more controlled pruning than random removal.

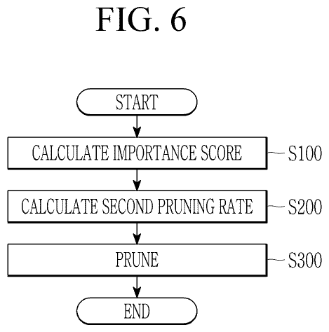

FIG. 6 shows an example of a method for pruning a deep learning model according to an example of the disclosure. For convenience, FIG. 6 is described by way of an example in which the steps are performed by a processor (e.g., control circuitry). One, some, or all steps of FIG. 6, or portions thereof, may be performed by one or more other circuits. One or some, steps of FIG. 6 may be omitted, performed in other orders, and/or otherwise modified, and/or one or more additional steps may be added.

Referring to FIG. 6, the method for pruning a deep learning model according to an example of the disclosure may include an importance score calculation operation (S100), a second pruning rate calculation operation (S200), and a pruning operation (S300).

In the importance score calculation operation (S100), the importance score calculator 110 may determine an importance score for each of the plurality of layers based on a similarity between the plurality of channels included in each of the plurality of layers. According to an example, the similarity between the plurality of channels may be calculated using a cosine similarity, a Euclidean distance, or a JSD.

According to an example, the importance score calculation operation (S100) may include an operation (S110) of determining a mean of a plurality of similarities as the importance score when the similarity between the plurality of channels is in plurality.

According to an example, the importance score calculation operation (S100) may include an operation (S120) of determining the sum of similarities that are higher than or equal to a reference value among the plurality of similarities as an importance score when there are a plurality of similarities between the plurality of channels.

According to an example, the importance score calculation operation (S100) may include an operation (S130) of determining a mean of the top N similarities having large similarity values among the plurality of similarities as an importance score when there are a plurality of similarities between the plurality of channels.

According to an example, the importance score calculation operation (S100) may further include an operation (S140) of quantifying, by the quantifier 111, the importance score for each of the plurality of layers within a preset range.

In the second pruning rate calculation operation (S200), the pruning rate calculator 120 may determine the first pruning rate for all of the plurality of layers based on the inference time of the pre-trained deep learning model 10 and determine the second pruning rate for each of the plurality of layers by multiplying the first pruning rate by the importance score.

According to an example, the second pruning rate calculation operation (S200) may include an operation (S210) of determining the first pruning rate for all of the plurality of layers, which renders the inference time of the pre-trained deep learning model 10 a reference value, and an operation (S220) of determining the second pruning rate for each of the plurality of layers by multiplying the first pruning rate by the importance score of each of the plurality of layers.

In the pruning operation (S300), the pruning unit 130 may prune each of the plurality of layers by randomly removing some of the plurality of channels for each of the plurality of layers with the second pruning rate.

The disclosure attempts to provide a device and method for pruning a deep learning model (or an artificial neural network model) capable of determining a pruning rate for each layer of a deep learning model.

According to an example, a device for pruning a deep learning model (or an artificial neural network model) includes: an importance score calculator configured to determine an importance score for each of a plurality of layers based on a similarity between a plurality of channels included in each of the plurality of layers included in a pre-trained deep learning model; a pruning rate calculator configured to determine a first pruning rate for all of the plurality of layers based on an inference time of the pre-trained deep learning model and to determine a second pruning rate for each of the plurality of layers by multiplying the first pruning rate by the importance score; and a pruning unit configured to randomly remove some of the plurality of channels at a second pruning rate for each of the plurality of layers to prune each of the plurality of layers.

The importance score calculator may determine the similarity between the plurality of channels using a cosine similarity.

The importance score calculator may determine the similarity between the plurality of channels using a Euclidean distance.

The importance score calculator may determine the similarity between the plurality of channels using a Jensen-Shannon divergence (JSD).

The importance score calculator may calculate, when the similarity between the plurality of channels is in plurality, a mean of the plurality of similarities as the importance score.

The importance score calculator may calculate, when the similarity between the plurality of channels is in plurality, a sum of similarities that are higher than a reference value among the plurality of similarities as the importance score.

The importance score calculator may calculate, when the similarity between the plurality of channels is in plurality, a mean of top N similarities having a largest similarity value among the plurality of similarities as the importance score.

The importance score calculator may include a quantifier configured to quantify the importance score for each of the plurality of layers within a preset range.

The pruning rate calculator may determine the first pruning rate for all of the plurality of layers, which renders the inference time of the pre-trained deep learning model a reference value.

According to another example, a method for pruning a pre-trained deep learning model including a plurality of layers includes: determining, by an importance score calculator, an importance score for each of a plurality of layers based on a similarity between a plurality of channels included in each of the plurality of layers; determining, by a pruning rate calculator, a first pruning rate for all of the plurality of layers based on the importance score and an inference time of the pre-trained deep learning model and to determine a second pruning rate for each of the plurality of layers by multiplying the first pruning rate by the importance score; and randomly removing, by a pruning unit, some of the plurality of channels at a second pruning rate for each of the plurality of layers to prune each of the plurality of layers.

The similarity between the plurality of channels may be calculated using cosine similarity.

The similarity between the plurality of channels may be calculated using an Euclidean distance.

The similarity between the plurality of channels may be calculated using a Jensen-Shannon divergence (JSD).

The determining of the importance score may include determining a mean of the plurality of similarities as the importance score when the similarity between the plurality of channels is in plurality.

The determining of the importance score may include: determining, when the similarity between the plurality of channels is in plurality, a sum of similarities that are higher than a reference value among the plurality of similarities as the importance score.

The determining of the importance score may include: determining, when the similarity between the plurality of channels is in plurality, a mean of top N similarities having a largest similarity value among the plurality of similarities as the importance score.

The determining of the importance score may include: quantifying the importance score for each of the plurality of layers within a preset range.

The determining of the second pruning rate may include: determining the first pruning rate for all of the plurality of layers, which renders the inference time of the pre-trained deep learning model a reference value; and determining the second pruning rate for each of the plurality of layers by multiplying the importance score of each of the plurality of layers by the first pruning rate.

According to an example of the disclosure, the speed and memory usage of the deep learning model may be effectively reduced, while the existing performance of the deep learning model is maintained.

According to an example of the disclosure, the pruning of the deep learning model does not require resources or costs, such as separate data, parameters, additional data collection, and learning.

Meanwhile, the method described above may be written as a program that may be executed on a computer and may be implemented in a general-purpose digital computer that operates the program using a computer-readable recording medium. The computer-readable storage medium may include a storage medium, such as a magnetic storage medium, such as a ROM, RAM, USB, floppy disk, or hard disk or an optical readable medium, such as a CD-ROM or DVD.

The scope of the disclosure is indicated by the claims described below rather than the detailed description above, and all changes or modifications derived from the meaning and scope of the claims and their equivalent concepts should be interpreted as being included in the scope of the disclosure.

What is claimed is:

1. An apparatus for controlling a robot, the apparatus comprising:
a processor;
a memory storing instructions that, when executed by the processor, are configured to cause the apparatus to:
determine, based on a similarity between a plurality of channels included in each of a plurality of layers, a plurality of weighting values for the plurality of layers, wherein the plurality of layers are included in a pre-trained deep learning model, and wherein each of the plurality of layers corresponds to a respective one of the plurality of weighting values;
determine, based on an inference time of the pre-trained deep learning model, a first pruning rate for all of the plurality of layers, wherein the inference time is associated with an amount of time taken for the pre-trained deep learning model to receive input data and predict an output value;
determine a second pruning rate for each of the plurality of layers by multiplying the first pruning rate by the respective one of the plurality of weighting values;
randomly remove at least one of the plurality of channels at the second pruning rate for each of the plurality of layers to prune each of the plurality of layers;
output, based on the pruned plurality of layers, a signal; and
control, based on the signal, the robot.

2. The apparatus of claim 1, wherein the instructions, when executed by the processor, are configured to cause the apparatus to determine, based on a cosine similarity, the similarity between the plurality of channels.

3. The apparatus of claim 1, wherein the instructions, when executed by the processor, are configured to cause the apparatus to determine, based on a Euclidean distance, the similarity between the plurality of channels.

4. The apparatus of claim 1, wherein the instructions, when executed by the processor, are configured to cause the apparatus to determine, based on a Jensen-Shannon divergence (JSD), the similarity between the plurality of channels.

5. The apparatus of claim 1, wherein the instructions, when executed by the processor, are configured to cause the apparatus to determine, based on a plurality of similarities between a plurality of channels of a first layer of the plurality of layers, a mean value of the plurality of similarities, wherein the mean value represents the weighting value of the first layer.

6. The apparatus of claim 1, wherein the instructions, when executed by the processor, are configured to cause the apparatus to determine, based on a plurality of similarities between a plurality of channels of a first layer of the plurality of layers, a sum of similarities that are higher than a reference value among the plurality of similarities, wherein the sum represents the weighting value of the first layer.

7. The apparatus of claim 1, wherein the instructions, when executed by the processor, are configured to cause the apparatus to determine, based on a plurality of similarities between a plurality of channels of a first layer of the plurality of layers, a mean value of top N similarities having a largest similarity value among the plurality of similarities, wherein the mean value of top N similarities represents the weighting value of the first layer.

8. The apparatus of claim 1, wherein the instructions, when executed by the processor, are configured to cause the apparatus to normalize each of the plurality of weighting values within a preset range.

9. The apparatus of claim 8, wherein the preset range is between 0.5 and 1.5.

10. The apparatus of claim 1, wherein the instructions, when executed by the processor, are configured to cause the apparatus to determine the first pruning rate for all of the plurality of layers, such that the inference time of the pre-trained deep learning model matches a reference value.

11. A method performed by an apparatus for controlling a robot, the method comprising:
determining, based on a similarity between a plurality of channels included in each of a plurality of layers, a plurality of weighting values for the plurality of layers, wherein each of the plurality of layers corresponds to a respective one of the plurality of weighting values;
determining, based on the plurality of weighting values and an inference time of a pre-trained deep learning model, a first pruning rate for all of the plurality of layers;
determining a second pruning rate for each of the plurality of layers by multiplying the first pruning rate by the respective one of the plurality of weighting values;
randomly removing at least one of the plurality of channels at the second pruning rate for each of the plurality of layers to prune each of the plurality of layers;
outputting, based on the pruned plurality of layers, a signal; and
controlling, based on the signal, the robot.

12. The method of claim 11, wherein the similarity between the plurality of channels is determined based on a cosine similarity.

13. The method of claim 11, wherein the similarity between the plurality of channels is determined based on an Euclidean distance.

14. The method of claim 11, wherein the similarity between the plurality of channels is determined based on a Jensen-Shannon divergence (JSD).

15. The method of claim 11, wherein the determining the plurality of weighting values comprises:
determining, based on a plurality of similarities between a plurality of channels of a first layer of the plurality of layers, a mean value of the plurality of similarities, wherein the mean value represents the weighting value of the first layer.

16. The method of claim 11, wherein the determining the plurality of weighting values comprises:
determining, based on a plurality of similarities between a plurality of channels of a first layer of the plurality of layers, a sum of similarities that are higher than a reference value among the plurality of similarities, wherein the sum represents the weighting value of the first layer.

17. The method of claim 11, wherein the determining the plurality of weighting values comprises:
determining, based on a plurality of similarities between a plurality of channels of a first layer of the plurality of layers, a mean value of top N similarities having a largest similarity value among the plurality of similarities, wherein the mean value of top N similarities represents the weighting value of the first layer.

18. The method of claim 11, wherein the determining the plurality of weighting values comprises:
normalizing each of the plurality of weighting values within a preset range.

19. The method of claim 18, wherein the preset range is between 0.5 and 1.5.

20. The method of claim 11, wherein the determining the second pruning rate comprises:
determining the first pruning rate for all of the plurality of layers, such that the inference time of the pre-trained deep learning model matches a reference value.
